(19) United States
(12) Patent Application Publication
(10) Pub. No.: US 2003/0099797 A1
(43) Pub. Date: May 29, 2003

(54) Lamp shade structure

(76) Inventor: Mei-Ju Juang, Shulin City (TW)

Correspondence Address: BACON & THOMAS, PLLC, 625 SLATERS LANE, FOURTH FLOOR, ALEXANDRIA, VA, 22314

(21) Appl. No.: 09/993,609

(22) Filed: Nov. 27, 2001

(51) Int. Cl. B32B 1/08

(52) U.S. Cl. 428/36.9; 362/358

(57) ABSTRACT

Lamp shade structure comprising a shade body and a frame body. The shade body is integrally made of fabric material and has a conic shape. Two ends of the shade body are respectively provided with a fixed fitting section and an extensible fitting section inbuilt with an elastic belt. The fitting sections are respectively snugly fitted around upper and lower edges of the frame body so that the shade body entirely encloses the frame body therein. The frame body is composed of multiple metal rods having predetermined pattern and connected with each other by latch members by way of clamping. A tray body is disposed on upper opening of the frame body to serve as a holder for bulb seat. All the metal rods of the frame body can be freely assembled and disassembled. After disassembled, the total volume of the frame body is greatly reduced to facilitate storage and transfer and lower the cost for transfer.

### BACKGROUND OF THE INVENTION

The present invention is related to a lamp shade structure in which the frame body can be freely assembled and disassembled to facilitate storage and transfer so as to lower transferring cost.

The existent lamp shades have common shortcomings as follows:

1. The lamp frame of the conventional lamp shade is made by welding and has rigid structure. However, such lamp shade cannot be disassembled.

2. The conventional lamp shade has an integrally made lamp frame and a shade sheet made of fabric or paper material. Such lamp shade has a considerably large volume and will occupy much room. This leads to difficulty in storage and transfer. Also, the number of the transferred lamp shades at one time is greatly reduced so that the transferring cost will be increased.

### SUMMARY OF THE INVENTION

It is therefore a primary object of the present invention to provide a lamp shade structure which can be conveniently assembled and disassembled without using any hand tool. The rigidity of the lamp shade will not be affected. The lamp shade can be mass-produced. After disassembled, the total volume of the frame body is greatly reduced to facilitate storage and transfer and avoid waste of space and lower the cost for transfer.

The lamp shade of the present invention has the following advantages:

1. The frame body of the lamp shade of the present invention is composed of independent metal rods and latch members which can be easily assembled and disassembled.

2. Two ends of the shade body of the lamp shade of the present invention are respectively provided with a fixed fitting section and an extensible fitting section. Therefore, the shade body is fitted around the frame body and is freely replaceable as desired.

3. The frame body and the tray body of the lamp shade of the present invention are detachably assembled by means of latch members so that the assembling procedure can be quickly and easily performed. After disassembled, the total volume of the lamp shade is greatly reduced to facilitate storage and transfer and lower the cost for transfer.

The present invention can be best understood through the following description and accompanying drawings wherein:

### BRIEF DESCRIPTION OF THE DRAWINGS

FIG. 1 is a perspective exploded view of the frame body of the lamp shade of the present invention;

FIG. 2 is a perspective assembled view of the frame body of the lamp shade of the present invention;

FIG. 3 shows that the metal rods of the lamp shade are connected by a latch member;

FIG. 4 shows the appearance of the lamp shade of the present invention; and

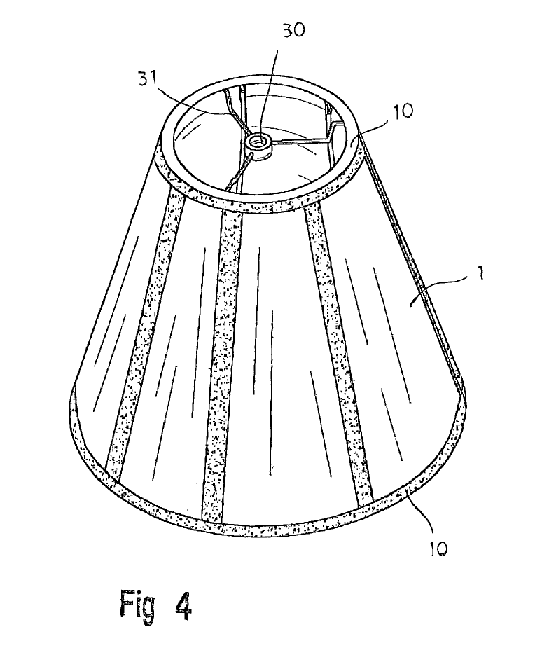

FIG. 5 shows that lamp shade of the present invention is disassembled into independent components for collective storage.

### DETAILED DESCRIPTION OF THE PREFERRED EMBODIMENT

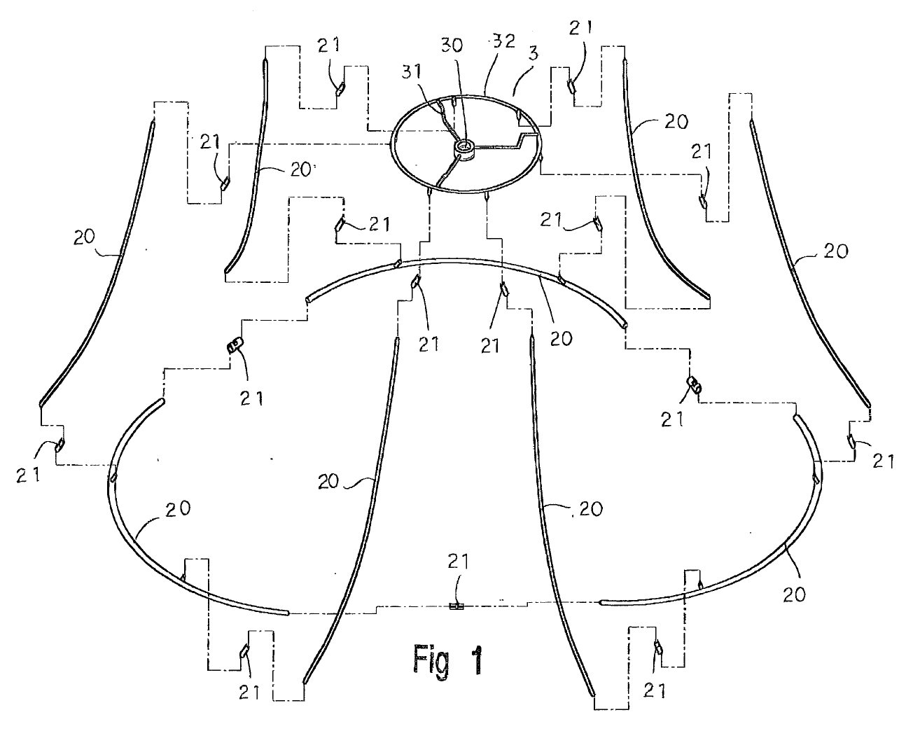

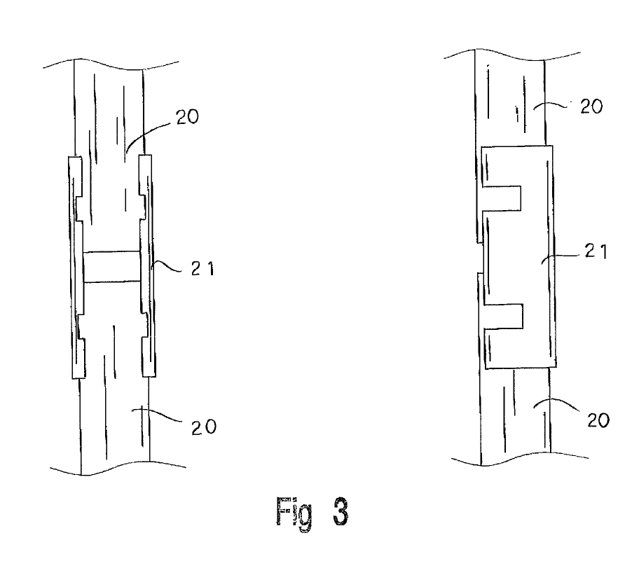

Please refer to FIGS. 1, 2 and 3. The lamp shade structure of the present invention includes a shade body 1, a frame body 2 and a tray body 3.

The shade body 1 is integrally made of fabric material and has a conic shape. Two ends of the shade body 1 are respectively provided with a fixed fitting section 10 and an extensible fitting section 10 inbuilt with an elastic belt. By means of the fitting sections 10, the shade body 1 is snugly fitted around the frame body 2 to entirely enclose the frame body 2.

The frame body 2 is composed of multiple metal rods 20 having predetermined pattern and connected with each other by latch members 21 by way of clamping. The tray body 3 is disposed on upper opening of the frame body 2 to serve as a holder for bulb seat. All. the metal rods 20 of the frame body 2 can be freely assembled and disassembled. After disassembled, the total volume of the frame body 2 is greatly reduced to facilitate storage and transfer and lower the cost for transfer.

The latch member 21 is made of a hard rigid or a slightly flexible material so as to tightly connect with the metal rods 20.

The tray body 3 has a central connecting section 30 for connecting with a bulb seat on which a bulb is rested. Three bent links 31 project from the periphery of the connecting section 30 at intervals to contain three angles. The three links 31 are welded with a metal ring 32.

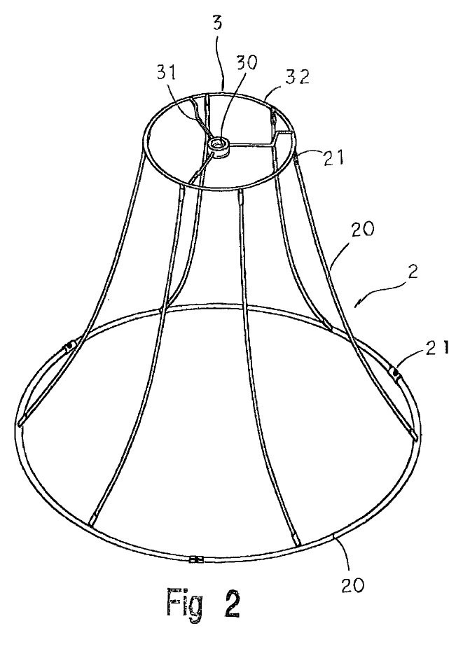

When assembled, each independent latch member 21 is used to truly connect two metal rods 20 with each other. The metal rods 20 are assembled one by one to form the frame body as shown in FIG. 2.

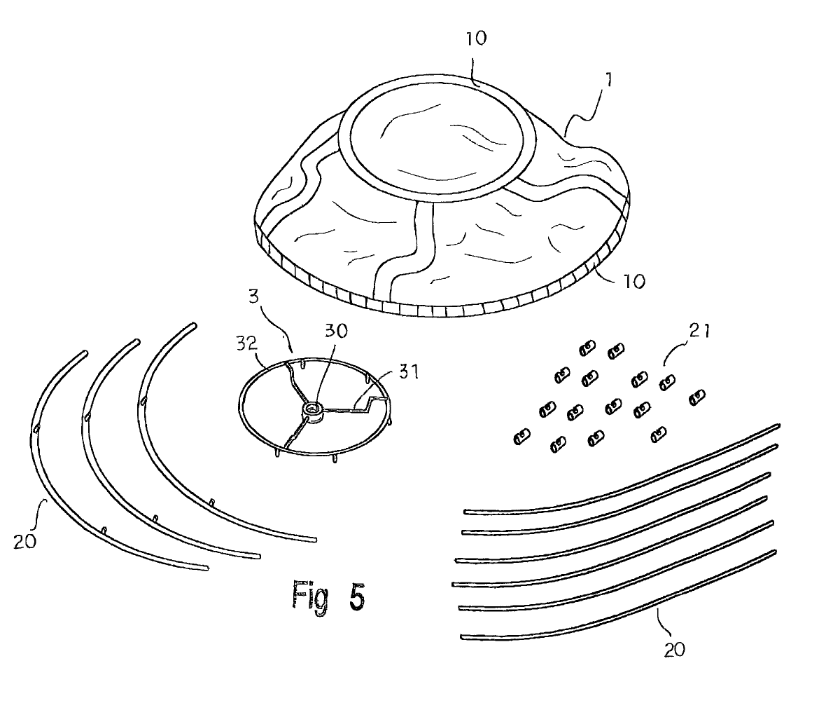

Referring to FIG. 5, the metal rods 20 and the latch members 21 of the frame body 2 are all independent components. When not used, these components are disassembled and collectively stored so as to minimize the volume of the lamp shade. In the case of mass-production, the components are respectively collectively stored. This makes it convenient to transfer the products and avoids waste of space.

The above embodiment is only used to illustrate the present invention, not intended to limit the scope thereof. Many modifications of the above embodiment can be made without departing from the spirit of the present invention.

What is claimed is:

1. Lamp shade structure comprising a shade body, a frame body and a tray body, the tray body having a central connecting section for connecting with a bulb seat on which a bulb is rested, three bent links projecting from the periphery of the connecting section at intervals to contain three angles, the three links being welded with a metal ring, said lamp shade structure being characterized in that:
the shade body shade body is an outermost layer integrally made of fabric material and having a substantially conic shape, two ends of the shade body being respectively provided with a fixed fitting section and an extensible fitting section inbuilt with an elastic belt, whereby by means of the fitting sections, the shade body can be snugly fitted around the frame body to entirely enclose the frame body; and
the frame body is disposed in the shade body and is composed of multiple metal rods connected with each other by latch members by way of clamping.
